(19) United States
(12) Patent Application Publication
(10) Pub. No.: US 2025/0036874 A1
(43) Pub. Date: Jan. 30, 2025

(54) PROMPT-BASED FEW-SHOT ENTITY EXTRACTION

(71) Applicant: Adobe Inc., San Jose, CA (US)

(72) Inventors: Inderjeet NAIR, Bangalore (IN); Vikas BALANI, Jodhpur (IN); Pritika RAMU, Bangalore (IN); Kumud LAKARA, Gurgaon (IN); Akshay SINGHAL, Shamli (IN); Anandhavelu N, Bangalore (IN)

(73) Assignee: Adobe Inc., San Jose, CA (US)

(21) Appl. No.: 18/360,721

(22) Filed: Jul. 27, 2023

(51) Int. Cl. G06F 40/284; G06F 40/40

(52) U.S. Cl. CPC G06F 40/284; G06F 40/40

(57) ABSTRACT

Techniques are disclosed for prompt-based few-shot entity extraction. The techniques include obtaining an annotated natural language document set for an arbitrary new entity type. A prompt sequence set is generated based on the annotated document set. A pre-trained entity extraction model is trained based on the prompt sequence set to yield a few-shot trained entity extraction model trained to extract at least the arbitrary new entity type. In response to obtaining a test document set, one or more entities of the arbitrary new entity type are extracted from the test document set using the few-shot trained entity extraction model.

### BACKGROUND

A language model is useful for natural language processing tasks such as entity extraction. Entity extraction is the computational task of analyzing natural language text to locate and classify entities mentioned in the text. Many state-of-the-art language models useful for entity extraction are based on artificial neural networks. Some neural network-based language models useful for entity extraction include the well-known Bidirectional Encoder Representations from Transformers (BERT) model and the well-known Denoising Autoencoder from Transformers (BART) model. A neural network-based language model is trained on a corpus of natural language text data to yield a pre-trained language model. The pre-trained language model is then used as is or trained for a particular entity extraction task.

The training data resources needed to train a pre-trained language model to accurately extract a new entity type affects the practicality of using such a model for that task. A new entity type is a type of entity that the pre-trained language model has not yet been trained to extract. Consider an example where a user wishes to use a web service to identify the short names of contractual parties in a collection of legal contracts where the pre-trained language model has not been trained with short name examples. For the web service, training the pre-trained language model to accurately extract the short names of contractual parties from unseen legal documents can require a large amount of annotated training data that may not be available or that would take many person-hours to generate. The web service may want to train the pre-trained language model using fewer training data resources. For example, asking the user to provide many annotated examples of a short name (e.g., hundreds) may not be practical as the user may not have the examples ready at hand and, as mentioned above, generating many examples can take substantial time and human resources.

### SUMMARY

Methods, systems, and non-transitory computer-readable media (collectively, techniques”) are provided for prompt-based few-shot entity extraction for arbitrary new entity types. The techniques encompass a prompt-based few-shot entity extraction pipeline system for training a pre-trained entity extraction model to perform entity extraction for a set of one or more “new” entity types that the pre-trained entity extraction model has not yet been trained to extract. The pipeline system operates in a training phase and an extraction phase.

During the training phase, input to the pipeline system includes a small set of annotated natural language text documents (“training documents”) in which text spans (e.g., words) corresponding to instances of the new entity type are indicated. Span sequences (e.g., sentences) encompassing the annotated spans (“training span sequences”) are extracted from the training documents. Prompts that are like the extracted training span sequences are selected from a library of pre-generated prompts. The prompts are combined with the corresponding training span sequences to form training prompt sequences. The training prompt sequences are used to train the pre-trained entity extraction model using a sequence generation approach modelled with explicit attention from the selected prompts over the corresponding training span sequences resulting in a few-shot trained entity extraction model.

During the extraction phase, input to the pipeline system includes a set of natural language text documents (“test documents”) from which instances of the new entity type are to be extracted. Span sequences (e.g., sentences) (“test span sequences”) are extracted from the test documents. Prompts that are like the extracted test span sequences are selected from the library of pre-generated prompts. The prompts are combined with the corresponding test span sequences to form test prompt sequences. The test prompt sequences are input to the few-shot trained entity extraction model which uses the sequence generation approach modelled with explicit attention from the selected prompts over the corresponding test span sequences to extract entities of the new entity type from the test span sequences.

Additional features and advantages of the techniques are set forth in the description which follows, and in part will be apparent from the description, or may be learned by the practice of the techniques.

### BRIEF DESCRIPTION OF THE DRAWINGS

The detailed description is described with reference to the accompanying drawings in which:

FIG. 1 illustrates a system and method for a training phase of prompt-based few-shot entity extraction, according to an embodiment.

FIG. 2 illustrates a method for generating training prompt sequences from training span sequences, according to an embodiment.

FIG. 3 illustrates a system and method for an entity extraction phase of prompt-based few-shot entity extraction, according to an embodiment.

FIG. 4 illustrates a method for generating test prompt sequences from test span sequences, according to an embodiment.

FIG. 5 illustrates a graphical user interface for annotating entities in a training document, according to an embodiment.

FIG. 6 illustrates a graphical user interface for annotating entities in a training document, according to an embodiment.

FIG. 7 illustrates a graphical user interface for extracting entities from a test document, according to an embodiment.

FIG. 8 illustrates a schematic diagram of a prompt-based few-shot entity extraction pipeline system, according to an embodiment.

FIG. 9 illustrates a flowchart of a series of acts in a method for prompt-based few-shot entity extraction, according to an embodiment.

FIG. 10 illustrates a block diagram of an exemplary processing device, according to an embodiment.

### DETAILED DESCRIPTION

Techniques are disclosed for prompt-based few-shot entity extraction that enable extraction of an arbitrary new entity type using a low resource training dataset. The amount of training data resources needed by a web service to train a pre-trained entity extraction model to accurately extract a new entity type is vitally important to the success of the web service. Unfortunately, training a pre-trained entity extraction model for such a task typically requires many examples (e.g., hundreds) of the new entity type. So, a less resource-intensive solution is needed. Along with the need for a solution that does not require as many training examples, there is a need for accuracy in extracting the new entity type.

Sequence labeling is an existing approach for entity extraction. With sequence labeling, a pre-trained entity extraction model encodes spans in span sequences and classifies encoded spans by entity type. Parameters of the pre-trained entity extraction model are shared among the entity types that the model is trained to extract. Because of the sharing of model parameters, training a pre-trained entity extraction model to extract a new entity type using a sequence labeling approach typically requires retraining the model with many examples of the new entity type.

Another existing approach uses sequence generation. With sequence generation, a pre-trained model is trained with a sequence-to-sequence objective to generate output sequences that identify spans in input sequences inferred by the model to be instances of an entity type. The sequence generation approach addresses the shared parameter issue of the sequence labeling approach. However, sequence generation by itself also typically requires many examples of the new entity type when training.

Another approach utilizes prompts to classify an event and extract spans relevant to the inferred event. The prompts provide information about the event type to reduce the number of new parameters that must be learned for each new event type. However, prompt approaches typically assume that the number of event categories is pre-determined. As a result, introducing a new event type involves both retraining and prompt tuning. Also, event-based prompt approaches leverage the repetition of events across documents to generate prompt information. In contrast, entities are often proper nouns having less or no repetition across a corpus of documents.

Techniques disclosed herein address issues with the existing approaches for entity extraction by using a combination of automatic prompt generation and sequence generation modelled with explicit attention from the generated prompts over document context. The techniques require only a small number of examples of a new entity type (e.g., ten to fifty) to train a pre-trained entity extraction model to accurately extract instances of the entity type from unseen documents. Since only a small number of examples are needed, training the pre-trained entity extraction model is accomplished in a relatively short amount of time such as only a few minutes or a few seconds. Likewise, annotating a set of documents to identify the small number of examples is accomplished by a user in a relatively short amount of time (e.g., minutes).

The techniques encompass a prompt-based few-shot entity extraction pipeline system for training a pre-trained entity extraction model to perform entity extraction for a set of one or more new entity types that the pre-trained entity extraction model has not yet been trained on. The pipeline system operates in a training phase and an extraction phase.

During the training phase, input to the pipeline system includes a small set of annotated natural language text documents (“training documents”) in which text spans (e.g., words) corresponding to instances of the new entity type are indicated. Span sequences (e.g., sentences) encompassing the annotated spans (“training span sequences”) are extracted from the training documents. Prompts that are like the extracted training span sequences are selected from a library of pre-generated prompts. A prompt is an annotated span sequence in which one or more spans in the span sequence are each annotated by an entity type. The prompts are combined with the corresponding training span sequences to form training prompt sequences. The training prompt sequences are used to train the pre-trained entity extraction model using a sequence generation approach modelled with explicit attention from the selected prompts over the corresponding training span sequences resulting in a few-shot trained entity extraction model.

During the extraction phase, input to the pipeline system includes a set of natural language text documents (“test documents”) from which to extract instances of the new entity type. Span sequences (e.g., sentences) (“test span sequences”) are extracted from the test documents. Prompts that are like the extracted test span sequences are selected from the library of pre-generated prompts. The prompts are combined with the corresponding test span sequences to form test prompt sequences. The test prompt sequences are input to the few-shot trained entity extraction model which uses the sequence generation approach modelled with explicit attention from the selected prompts over the corresponding test span sequences to extract entities of the new entity type from the test span sequences.

As an example of the problem addressed by the techniques disclosed herein, consider a user that wishes to extract a new entity type from a collection of test documents. As mentioned, requiring the user to annotate a large corpus of training documents identifying many in-context examples of the new entity type may not be practical. In contrast, the disclosed techniques allow the user to extract the new entity type in a few-shot setting.

The techniques proceed by obtaining a small set of annotated training documents (e.g., ten to twenty documents) from the user. The annotations identify text spans (or just “spans” for short) in the documents corresponding to instances of the entity type. For example, the set of documents may be a set of legal contracts and the entity type may be the short name of contractual parties. A short name is an alias given to a contractual party so that it can be referred to conveniently in the remainder of the contract. For example, “Acme Corporation” may be a contractual party in a contract given the short name “Lender.” A pre-trained entity extraction model pre-trained based on a set of “standard” entity types such as, for example, contractual party may not have been trained to extract this particular entity type and thus the entity type is new with respect to the pre-trained entity extraction model.

Continuing this example, the declaration of short names is typically made at the beginning of a contract. But there is no standard natural language format for how the declaration of a short name should be made. For example, a short name can be enclosed within parentheses, or it can appear in natural language text. The position of a short name can be before or after the full name of the contracting party. As a result, a rule-based or heuristic-based method is not reliable for extracting arbitrary entity types like short name from natural language documents.

Once the small set of annotated training documents is obtained from the user, the techniques proceed with a short training phase where a pre-trained entity extraction model is trained to extract the new entity type. Since only a small set of training documents is required to train the pre-trained entity extraction model to extract the new entity type, the training phase is relatively short such as only a few minutes or a few seconds. Likewise, annotating the set of training documents is accomplished by the user in a short amount of time.

The techniques enable accurate entity extraction from natural language documents for arbitrary new entity types requiring only a small set of annotated examples to extract the entity types from unseen documents. Additionally, the techniques improve the functioning of a set of one or more processing devices that implement the techniques because a pre-trained entity extraction model is trained to extract a set of one or more new entity types using a low resource training set, thereby consuming fewer computing resources (e.g., fewer CPU cycles and less storage space of data storage devices) compared to other approaches. The techniques and the technical benefits thereof will now be described with respect to the figures.

### Training Phase

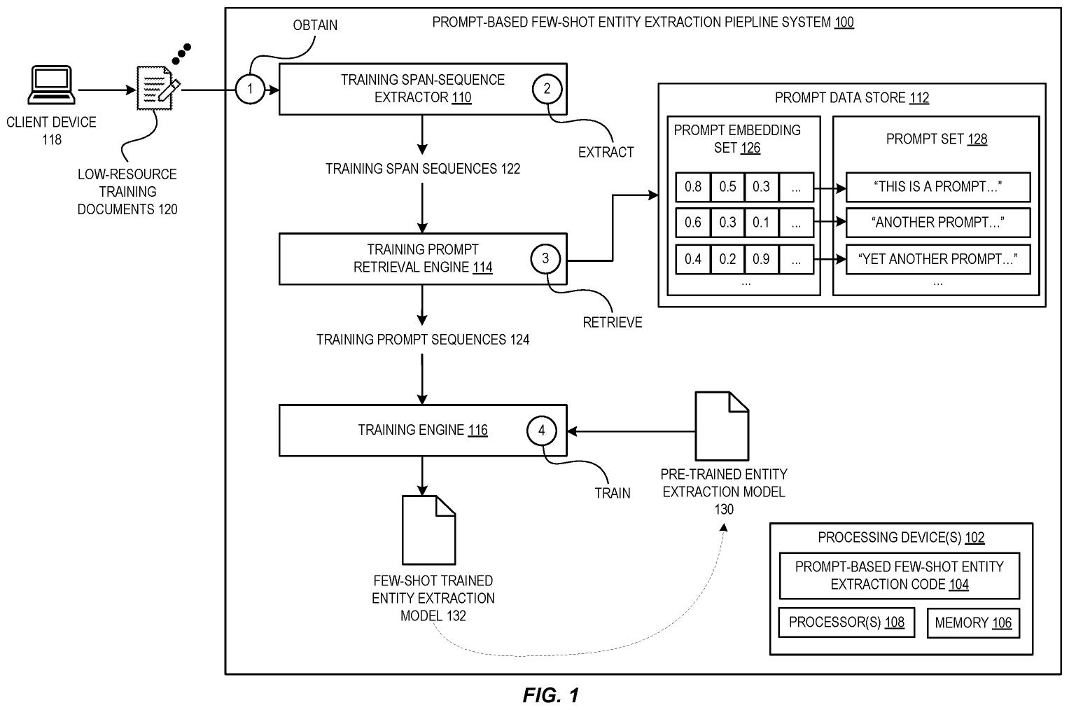

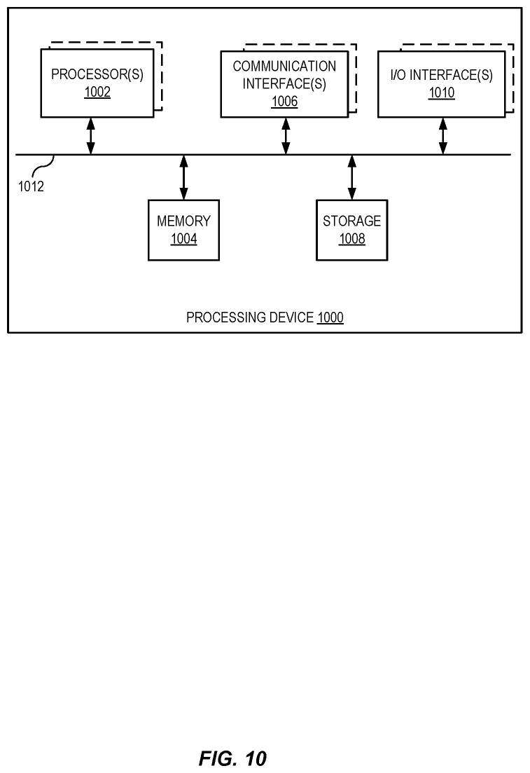

FIG. 1 illustrates a system and a method for a training phase of prompt-based few-shot entity extraction, according to an embodiment. In summary, the system includes prompt-based few-shot entity extraction pipeline system 100 (or “pipeline system 100” for short). Pipeline system 100 is implemented by a set of one or more processing devices 102. The set of processing devices 102 encompasses prompt-based few-shot entity extraction code 104 (or “code 104” for short) configured to perform the method. The set of processing devices 102 includes memory 106 for storing code 104 and a set of one or more processors 108 for executing code 104 stored in memory 106. An example of a processing device is described below with respect to FIG. 10.

Steps of the method are depicted in FIG. 1 by numbered circles that overlay directed arrows. The directed arrows represent a direction of data flow between connected components but not necessarily the exclusive direction. The method is performed by pipeline system 100 because of the set of one or more processors 108 executing code 104 stored in memory 106. Pipeline system 100 also encompasses training span sequence extractor 110, prompt data store 112, training prompt retrieval engine 114, and training engine 116. Each of these components is implemented by the set of one or more processing devices 102 of pipeline system 100.

The system also includes client device 118 in addition to pipeline system 100. Client device 118 is a processing device such as, for example, a processing device with some or all the hardware components described below with respect to example processing device 1000 of FIG. 10. Client device 118 programmatically interfaces with pipeline system 100 via an application programming interface (API) offered by pipeline system 100 to client device 118 and potentially other client devices. Such interfacing is facilitated by an inter-process communication mechanism or data communications network that facilitates the exchange of data between client device 118 and pipeline system 100 according to the API.

In summary, the method proceeds at step 1 by pipeline system 100 obtaining annotated training documents 120 from client device 118 for a first set of one or more new entity types. At step 2, training span sequence extractor 110 extracts training span sequences 122 from training documents 120. At step 3, training prompt retrieval engine 114 generates training prompt sequences 124 based on training span sequences 122. At step 4, training engine 116 trains pre-trained entity extraction model 130 based on training prompt sequences 124 to yield few-shot trained entity extraction model 132 that has been trained to extract the first set of new entity types.

Optionally, few-shot trained entity extraction model 132 is used as the pre-trained entity extraction model for a next performance of the method for an additional set of one or more new entity types which will yield yet another few-shot trained entity extraction model that been trained to extract both the first and the additional sets of new entity types. In some embodiments, the method is repeated in this way to evolve the entity extraction model over time to extract new entity types as the need arises.

Returning to the top of the method of FIG. 1, at step 1, training span sequence extractor 110 of pipeline system 100 obtains training documents 120 for a “target” set of one or more arbitrary new entity types. The set of target entity types are arbitrary in the sense that no particular target entity type is required. The set of target entity types are new in that pre-trained entity extraction model 130 has not yet been trained to extract the set of target entity types. For example, pre-trained entity extraction model 130 may not have been trained using training examples labeled by the set of target entity types.

Training documents 120 encompasses natural language documents with annotated spans. The natural language documents contain text written or generated in a natural language (e.g., English or other natural language), possibly in addition to other types of document content (e.g., audio, video, or image data). The text is human authored or computer-generated (e.g., by a generative artificial intelligence process). Examples herein as based on contractual documents in a legal domain. In some embodiments, the natural language documents belong to a particular domain such as a legal, financial, medical, scientific, or research domain. However, the techniques are not limited to a particular domain.

Training documents 120 is “low resource” in that it has comparatively fewer annotated spans for each target entity type from which a model learns from. For example, a rich-resource training data set may encompass hundreds annotated spans for each entity type. In contrast, training documents 120 encompass a relatively small number of annotated spans for each target entity type. In some embodiments, training documents 120 encompass between ten and fifty annotated spans for each target entity type.

Training documents 120 encompasses span annotation metadata identifying one or more annotated spans that are instances of a target entity type. In some embodiments, the span annotation metadata is embedded or is part of the documents themselves. In some embodiments, the span annotation metadata is contained in one or more separate documents or files. The span annotation metadata identifies a span in a document by a mechanism such as by tags, references, addresses, offsets, coordinates, or the like. A “span” is a sequence of consecutive text characters. For example, a span can be one or more consecutive words. A span is also equivalently referred to in some contexts as a “token.”

At step 2, training span sequence extractor 110 extracts training span sequences 122 encompassing the annotated spans from training documents 120. Each training span sequence encompasses at least one annotated span from a document in training documents 120 and text of the document preceding or following the annotated span in the document. For example, an extracted training span sequence can be the sentence or the paragraph of the training document in which an annotated span appears. There is no requirement that a training span sequence be a sentence or a paragraph, however. For example, a training span sequence can be selected as an annotated span from a document and up to a pre-determined number of text characters preceding the annotated span in the document and up to a pre-determined number of text characters following the annotated span in the document.

A training span sequence of training span sequences 122 is labeled by (associated with) an entity type that it contains an annotated span instance of. For example, for a “contracting party” entity type, both “Acme Inc.” and “Example.Com Company” can be annotated spans in the training span sequence: “This contract is signed between Acme Inc. and the Example.Com Company on the 12^{th} of May 2022.” In this case, the training span sequence can be labeled with (associated with) the text “CONTRACTING PARTY,” which is an assigned text label for the contracting party entity type. No particular text label or text label format is required for a given entity type. In some embodiments, a consistent label and label format for an entity type is used across training span sequences. This example also illustrates the possibility that a training span sequence can contain multiple annotated spans for an entity type.

In some embodiments, a training span sequence contains annotated spans of different entity types. In this case, training span sequences 122 contains multiple training span sequences for the same document context. For example, in the example sentence above, the spans “Acme. Inc. and “Example.Com Company” could be annotated as instances of the contracting party entity type and the span “12^{th} of May 2022” could be annotated as an instance of an “execution date” entity type. In this case, two instances of a training span sequence can be included in training span sequences 122 for this sentence: one where the sentence is labeled “CONTRACTING PARTY” and another where the sentence is labeled “EXECUTION DATE.”

At step 3, training span sequences 122 are input to training prompt retrieval engine 114 to generate training prompt sequences 124. A training prompt sequence combines a training span sequence with a prompt generated by training prompt retrieval engine 114 for the training span sequence. A prompt is an annotated span sequence that provides a representation of a context in which an entity type appears including the location or locations within the context in which the entity type appears. By leveraging the prompts in training prompt sequences 124 using an attention mechanism of a sequence generation approach as described in greater detail herein, pre-trained entity extraction model 130 is trained to accurately extract a target entity type using relatively few training prompt sequences.

### Training Phase—Prompt Generation

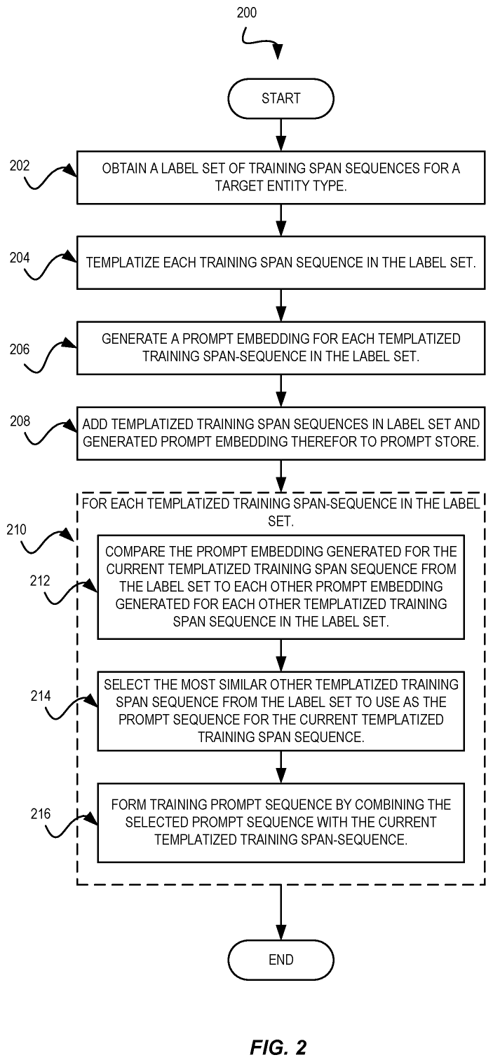

FIG. 2 illustrates method 200 performed by training prompt retrieval engine 114 to generate training prompt sequences 124 from training span sequences 122, according to some embodiments. The steps of the method are performed for each set of training span sequences, of training span sequences 122, labeled by a target entity type. If training span sequences 122 encompasses multiple target entity types, then method 200 is performed multiple times, once for each target entity type that training span sequences 122 encompasses. In some embodiments, when method 200 is performed multiple times for multiple target entity types, the performances of method 200 are performed concurrently or in parallel. There is no requirement that the performances be conducted sequentially.

At step 202, training prompt retrieval engine 114 obtains a “label” set of training span sequences for a target entity type from training span sequences 122. The label set encompasses all training span sequences 122, if training span sequences 122 encompasses (is labeled by) just one target entity type, or a subset of training span sequences 122, if training span sequences 122 encompasses (is labeled by) multiple target entity types.

At step 204, each training span sequence in the label set for the target entity type is templatized by the target entity type. In particular, the training span sequence is prefixed with a text label for the target entity type and each instance of the target entity type in the training span sequence is replaced in place with the text label for the target entity type. Templatization helps the model better learn the location of the target entity type in context. For example, consider the example training span sequence: ‘This Employment Agreement (the “Agreement”) is made as of Mar. 7, 2018, by and between Acme, Inc., a Michigan corporation (the “Company”), and Sally Boss (“Executive”), subject to the terms and conditions defined in this Agreement.’ If the entity type is short name, then the example training span sequence could be templatized as: ‘SHORT NAME | This Employment Agreement (the “Agreement”) is made as of Mar. 7, 2018, by and between Acme, Inc., a Michigan corporation (the “SHORT NAME”), and Sally Boss (“SHORT NAME”), subject to the terms and conditions defined in this Agreement.’ Here, the text label “SHORT NAME” replaces the occurrences of the short name entity type in the original training span sequence and is used in the prefix “SHORT NAME |.” In some embodiments, a character such as the vertical bar character (‘|’) is used to syntactically separate the prefix from the remaining portion of the templatized training span sequence. In some embodiments, a different prefix separator character is used, or no prefix separator character is used.

At step 206, a prompt embedding is generated for each templatized training span sequence in the label set for the target entity type. A prompt embedding represents an entire templatized training span sequence in a single vector. For example, a prompt embedding can encompass a classification (CLS) embedding generated by a pre-trained “prompt” language model. For example, the prompt language model can be based on a well-known transformer-based language model such as BERT, GPT-2, ROBERTa, T5, or the like that has been pre-trained on a corpora of text data using unsupervised learning techniques.

The pre-training of the prompt language model involves a reference corpus of text data from which to learn representations for annotated spans in the reference corpus. For example, the reference corpus could be a domain-specific corpus such as a corpus of legal, scientific, financial, or medical documents in which spans are annotated by various entity types. The reference corpus, however, is not required to have any annotated instances of a target entity type.

The training of the prompt language model involves the use of an unsupervised objective like masked language modeling. Here, the prompt language model is trained to predict the masked annotated spans in a span sequence extracted from the reference corpus given a remainder of the span sequence. During the training process, the prompt language model learns to represent the span sequences in a way that allows the prompt language model to accurately predict the masked annotated spans.

In some embodiments, the prompt embedding is generated for a templatized training span sequence (input sequence) as follows. The pre-trained prompt language model tokenizes the input sequence into spans. In doing so, the pre-trained prompt language model adds special spans to the input sequence. For example, the pre-trained prompt language model may add a [CLS] span at the beginning of the input sequence and a [SEP] span at the end of the input sequence to indicate the separation between input and output. Then, the pre-trained prompt language model generates a sequence of embeddings given the tokenized input sequence with the special tokens added through a forward pass of the pre-trained prompt language model. The generated sequence of embeddings by the forward pass includes an embedding of the CLS span added to the input sequence. In some embodiments, this embedding is used as the prompt embedding for the templatized training span sequence.

At step 208, the templatized training span sequences in the label set for the target entity type are added to prompt set 128 in prompt data store 112 along with their corresponding generated prompt embeddings as part of prompt embedding set 126, to be used later during the training phase and the extraction phase.

At step 210, steps 212, 214, and 216 are performed for each templatized training span sequence in the label set for the target entity type. At step 212, the prompt embedding generated at step 206 for the current templatized training span sequence in the label set is compared to each prompt embedding generated for each other templatized training span sequence in the label set. The comparison is for similarity according to a similarity measure. For example, the cosine distance or other similarity measure (e.g., a Euclidean distance or a dot product) for the prompt embeddings can be computed.

At step 214, the other templatized training span sequence that is not the current templatized span sequence in the label set that is most similar to the current templatized span sequence in the label set according to the similarity measure is selected as the prompt for the current templatized training span sequence in the label set.

At step 216, a prompt sequence is formed for the current templatized training span sequence in the training set by combining (e.g., concatenating) the selected prompt and the current templatized training span sequence in the label set.

By method 200, training prompt retrieval engine 114 generates a training prompt sequence for each templatized training span sequence in the label set for the target entity type. The training prompt sequence encompasses a combination (e.g., a concatenation) of the selected prompt and the templatized training span sequence. In this way, training prompt sequences 124 are generated by training prompt retrieval engine 114 for all target entity types encompassed by training span sequences 122 extracted from training documents 120.

Returning now to FIG. 1, at step 4, training engine 116 trains pre-trained entity extraction model 130 with a sequence-to-sequence training objective in a few-shot setting based on training prompt sequences 124 generated by training prompt retrieval engine 114. In some embodiments, pre-trained entity extraction model 130 comprises a pre-trained sequence-to-sequence entity extraction model. Pre-trained entity extraction model 130 is a type of deep artificial neural network. Pre-trained entity extraction model 130 encompasses an encoder and a decoder. The encoder processes an input sequence and generates a fixed-length context vector. The context vector summarizes the meaning of the input sequence. The context vector is used by the decoder to generate an output sequence. The decoder generates the output sequence a span at a time, using the context vector and internal state to decide what span to generate next according to a probability distribution over a set of spans. Pre-trained entity extraction model 130 is trained by providing input/source-output/target sequence pairs. During training, the encoder and decoder is optimized to minimize the difference between generated output sequences and actual target sequences.

Pre-trained entity extraction model 130 includes an attention mechanism. The attention mechanism is used to selectively focus on certain parts of the input sequence while generating the output. The attention mechanism allows pre-trained entity extraction model 130 to dynamically weigh the importance of different parts of the input sequence when making predictions, rather than using a fixed-length context vector to summarize the input sequence.

The attention mechanism takes as input the current decoder state and the output from the encoder and computes a weight for each element in the input sequence. These weights represent the importance of each element in the input sequence for the current decoding step. The weighted sum of the input elements is then used as additional input to the decoder, allowing the decoder to capture the dependencies between elements in the input sequence and make use of the information available in the input sequence.

There are two different types of attention in pre-trained entity extraction model 130: self-attention and cross-attention. Self-attention is used in pre-trained entity extraction model 130 to allow each element in a sequence to attend to all other elements in the same sequence when generating the output. Self-attention helps pre-trained entity extraction model 130 better capture the dependencies between elements in the sequence and make better use of the information available in the sequence. In the context of pre-trained entity extraction model 130, self-attention is used in the decoder to attend over the spans of an output sequence that the decoder has generated so far for a given input sequence. For the case of the encoder, self-attention involves making a span present in the input sequence attend over every other span present in the input sequence.

Cross-attention in pre-trained entity extraction model 130 allows the decoder to attend to the input sequence when generating the output sequence for the input sequence. Cross-attention helps the decoder to understand the context of the input sequence and make informed decisions while generating the output. With cross-attention, the spans of the output sequence generated so-far by the decoder for a given input sequence attends over spans in the input sequence.

Pre-trained entity extraction model 130 is pre-trained on a large (high resource) annotated training corpus. Additionally, or alternatively, pre-trained entity extraction model 130 is a prior few-shot trained entity extraction model generated for earlier seen set of one or more arbitrary new entity types.

In some embodiments, pre-trained entity extraction model 130 encompasses a Copy-BART language model. The Copy-BART language model is a variant of the Denoising Autoencoder from Transformers (BART) language model. Like BART, Copy-BART is a transformer-based language model. However, unlike other Seq2Seq language models that generate output sequences by sampling from a fixed vocabulary, Copy-BART decoder copies spans from the input sequences into the output sequences. This allows Copy-BART to better preserve important information from the input sequences. The ability of Copy-BART to copy spans from input sequences also helps to reduce or eliminate a problem of other Seq2Seq models that generate out-of-vocabulary (OOV) spans. Generating OOV spans is detrimental to entity extraction as some extracted entities are proper nouns that are not in the fixed vocabulary. Copy-BART resolves this OOV issue by modelling distribution over a fixed vocabulary and the vocabulary of the input sequences. As the entities to be extracted will be present in training prompt sequences 124, using Copy-BART reduces or eliminates the OOV issue.

Training prompt sequences 124 are represented by training engine 116 as a set of (SS, P) pairs where SS represents a non-templatized training span sequence in training span sequences 122 and P represents the corresponding training prompt generated by training prompt retrieval engine 114 for span sequence SS. Both span sequence SS and prompt P represent a sequence of spans (e.g., words or tokens).

Let the parameter IS represent the input sequence formed by combining (e.g., concatenating) span sequence SS and prompt P where the parameter IS represents the sequence: ss1, ss2, . . . , ssn, p1, p2, . . . , pk. Here, the parameters ss1, ss2, . . . , ssn represent in-order spans (e.g., words or tokens) from span sequence SS and parameters p1, p2, . . . , pk represent spans (e.g., words or tokens) from prompt P.

During the forward pass, training engine 116 feeds input sequence IS to the encoder of pre-trained entity extraction model 130 to obtain contextual embeddings (contextualized feature vectors) for the spans in the IS. Let the parameter W represent the set of contextualized embeddings generated by the encoder of pre-trained entity extraction model 130 for spans of the span sequence SS in input sequence IS. The parameter W represents the sequence: w1, w2, . . . , wn where the parameter w1 represents the contextualized embedding for span ss1 of IS, the parameter w2 represents the contextualized embedding for span ss2 of input sequence IS, and the parameter wn represents the contextualized embedding for span ssn of input sequence IS. Let the parameter Z represent the set of contextualized embeddings (contextualized feature vectors) generated by the encoder of pre-trained entity extraction model 130 for spans of the prompt P input sequence IS. The parameter Z represents the sequence: z1, z2, . . . , zk where the parameter z1 represents the contextualized embedding for span p1 of input sequence IS, the parameter z2 represents the contextualized embedding for span p2 of input sequence IS, and the parameter zn represents the contextualized embedding for span pk of input sequence IS.

During the forward pass, the output sequence Y generated by the decoder of pre-trained entity extraction model 130 for the input sequence IS until time step t is represented as the parameter Y. The parameter Y represents the sequence: y1, y2, . . . , yt where y1 represents the first span of the output sequence Y, y2 represents the second span of the output sequence Y, and yt represents the t-th span of the output sequence Y at time-stamp t. The parameter S represents the corresponding feature vectors for the spans of Y. In particular, the parameter S represents the sequence: s1, s2, . . . , st for respective spans y1, y2, . . . , yt.

During training, training engine 116 generates an input sequence embedding by explicitly attending over the prompt embeddings Z. The encoder of pre-trained entity extraction model 130 generates a contextualized embedding w1, w2, . . . , wn and z1, z2, . . . , zk for each of the spans ss1, ss2, . . . , ssn, p1, p2, . . . , pk in the input sequence IS. Additionally, a single embedding representing the input sequence is generated by involving explicit attention from the prompt embeddings z1, z2, . . . , zk. This is done by computing an attention vector for each span in the span sequence SS using the contextualized embeddings Z for the prompt P. These attention vectors are then used to form a weighted linear combination W-Combined of the contextualized embeddings W for the span sequence SS. The steps for computing W-Combined are represented by the following two functions:

$${A}_{i} = \frac{1}{k} {\sum }_{j = 1}^{k} {a}_{ij} {t}_{j} where {a}_{ij} = cos ( {w}_{i} , {z}_{j} )$$

In the above-equation, the parameter Aᵢ represents the attention vector for the i-th span of span sequence SS and cos(wᵢ,zⱼ) represents the cosine similarity between (a) the contextualized embedding wᵢ of contextualized embeddings W for the i-th span of span sequence SS and (b) the contextualized embedding zⱼ of contextualized embeddings Z for the j-th span of prompt P.

$$W - Combined = {\sum }_{i = 1}^{n} {f}_{i} {w}_{i} where {f}_{i} = {A}_{i}^{z} {\sum }_{i = 1}^{n} {w}_{i}$$

In the above equation, the parameter W−Combined represents a weighted linear combination of the contextualized embeddings W. The parameter W−Combined plays an important role in modelling the distribution from which the next element in the output sequence is generated.

Training engine 116 models a distribution over both a fixed vocabulary represented and the span sequence SS. The parameter P_{gen} represents the emphasis the decoder gives to the fixed vocabulary over the span sequence SS. In some embodiments, the parameter P_{gen} is represented by the following function:

P_{gen}=sigmoid (W−Combined×sₜ) where st represents the hidden state of the decoder at time step t for the most recently generated span by the decoder.

Modeling the distribution to generate the next span in the output sequence involves the computation by training engine 116 of both the distribution over the fixed vocabulary and the distribution over the span sequence SS. Specifically, the representation of last generated span from the decoder is used for computing the distribution over the fixed vocabulary using parameters W_{vocab}, b_{vocab}.

$${P}_{vocab} = softmax ( {W}_{vocab} {S}_{t} + {b}_{vocab} )$$

Training engine 116 also computes a distribution over the spans in the span sequence SS represented by P_{copy} such that P_{copy}(ssᵢ) is set to the cross-attention value between the encoder and decoder corresponding to span ssᵢ. Thus, the final distribution of generating the next span is governed by the following function:

$$P = {P}_{gen} {P}_{vocab} + ( 1 - {P}_{gen} ) {P}_{copy}$$

Training engine 116 trains pre-trained entity extraction model 130 over training prompt sequences 124 using a sequence-to-sequence objective. In some embodiments, training engine 116 trains pre-trained entity extraction model 130 to minimize the following loss function where P is computed as above.

$$Loss = - {\sum }_{i = 1}^{\vert Y \vert} log ( P ( Y [ i ] ) )$$

As a result of the training (training) of pre-trained entity extraction model 130 based on training prompt sequences 124, few-shot trained entity extraction model 132 is produced. Few-shot trained entity extraction model 132 is pre-trained entity extraction model 130 additionally trained (trained) based on training prompt sequences 124 to extract the target entity type(s).

### Extraction Phase

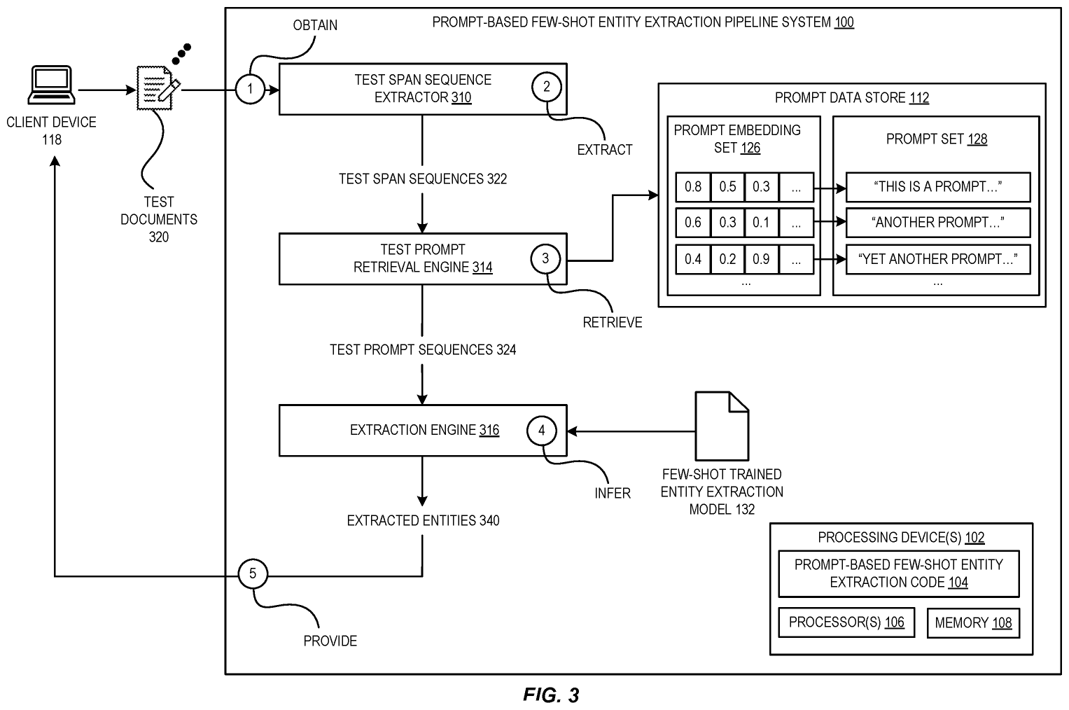

Turning now to FIG. 3, it illustrates a system and a method for an extraction phase of prompt-based few-shot entity extraction, according to an embodiment. In summary, the system includes pipeline system 100. The system also includes client device 118 in addition to pipeline system 100.

Steps of the method are depicted in FIG. 3 by numbered circles that overlay directed arrows. The directed arrows represent a direction of data flow between connected components but not necessarily the exclusive direction. The method is performed by pipeline system 100 because of the set of one or more processors 108 executing code 104 stored in memory 106. Pipeline system 100 also encompasses test span sequence extractor 310, prompt data store 112, test prompt retrieval engine 314, and extraction engine 316. Each of these components is implemented by the set of one or more processing devices 102 of pipeline system 100.

In summary, the method proceeds at step 1 by pipeline system 100 obtaining test documents 320 from client device 118 from which entities of the target entity type(s) are to be extracted. At step 2, test span sequence extractor 310 extracts test span sequence set 322 from test documents 320. At step 3, test prompt retrieval engine 314 generates test prompt sequences 324 based on test span sequence set 322. At step 4, extraction engine 316 uses few-shot trained entity extraction model 132 to extract (infer) extracted entities 340 which identifies instances of the target entity type(s) in test documents 320. At step 5, extracted entities 340 is provided to client device 118.

Returning to the top of the method of FIG. 3, at step 1, test span sequence extractor 310 of pipeline system 100 obtains test documents 320 for a set of one or more “target” entity types to be extracted from test documents 320 that few-shot trained entity extraction model 132 was trained to extract during the training phase as described in greater detail herein.

Test documents 320 encompasses natural language documents. Unlike training documents 120, test documents 320 does not need to be annotated by a target entity type. Further, unlike training documents 120, test documents 320 need not be low resource. In some embodiments, the size of test documents 320 in terms of number of documents in test documents 320 is much larger than the size of training documents 120. In some embodiments, however, test documents 320 encompass just a single document or only a few documents. The natural language documents contain text written or generated in a natural language (e.g., English, or other natural language), possibly in addition to other types of document content (e.g., audio, video, or image data). The text is human authored or computer-generated (e.g., by a generative artificial intelligence process). Examples herein as based on contractual documents in a legal domain. In some embodiments, the natural language documents belong to a particular domain such as a legal, financial, medical, scientific, or research domain. However, the techniques are not limited to a particular domain.

At step 2, test span sequence extractor 310 extracts test span sequences 322 from test documents 320. For example, test span sequences 322 can encompass sentences, paragraphs, or other consecutive groups of words extracted from test documents 320.

At step 3, test span sequences 322 are input to test prompt retrieval engine 314 to generate test prompt sequences 324. Test prompt sequences 324 are generated by test prompt retrieval engine 314 from test span sequences 322 in a manner like how training prompt retrieval engine 114 generates training prompt sequences 124 from training span sequences 122 with some differences.

### Extraction Phase—Prompt Generation

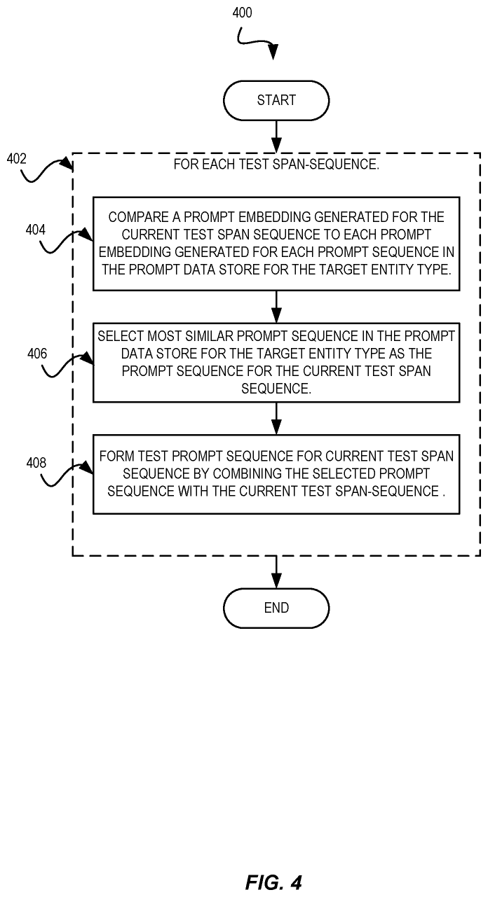

FIG. 4 illustrates method 400 performed by test prompt retrieval engine 314 to generate test prompt sequences 324 from test span sequences 322, according to an embodiment. The steps of the method are performed for each target entity type that is to be extracted from test documents 320. If multiple target entity types are to be extracted from test documents 320, then method 400 is performed multiple times, once for each target entity type to be extracted. When method 400 is performed multiple times for multiple target entity types, the performances of method 400 are performed concurrently or in parallel in some embodiments. There is no requirement that the performances be conducted sequentially.

At step 402, steps 404, 406, and 408 are performed for each test span sequence in test span sequences 322. At step 404, a prompt embedding generated for the current test span sequence is compared to each prompt embedding in prompt embedding set 126 that was generated during the training phase for each templatized training span sequence for the target entity type in prompt set 128. The prompt embedding for the test span sequence is generated using the pre-trained prompt language model as described elsewhere herein. The comparison is for similarity according to a similarity measure. For example, the cosine distance or the other similarity measure (e.g., a Euclidean distance or a dot product) between the prompt embeddings can be computed. At step 406, the templatized training span sequence for the target entity type in prompt set 128 that is most like the current test span sequence is selected as the prompt for the current test span sequence. At step 408, a test prompt sequence is formed for the current test span sequence by combining (e.g., concatenating) the selected prompt and the current test span sequence.

By method 400, test prompt retrieval engine 314 generates a test prompt sequence for each test span sequence for each target entity type. The test prompt sequence encompasses a combination (e.g., a concatenation) of the selected test prompt and the test span sequence. In this way, test prompt sequences 324 are generated by test prompt retrieval engine 314 for all target entity types to be extracted from test documents 320.

Returning now to FIG. 3, at step 4, entity extraction engine 316 uses few-shot trained entity extraction model 132 to extract (infer) the target entity(s) from test prompt sequences 324. Test prompt sequences 324 are represented by extraction engine 316 as a set of (SS, P) pairs where SS represents a test span sequence in test span sequence set 322 and P represents the corresponding prompt generated by test prompt retrieval engine 314 for span sequence SS and a target entity type.

Let the parameter IS represent the input sequence formed by combining (e.g., concatenating) span sequence SS and prompt P where the parameter IS represents the sequence: ss1, ss2, . . . , ssn, p1, p2, . . . , pk. Here, the parameters ss1, ss2, . . . , ssn represent in-order spans (e.g., words or tokens) from span sequence SS and parameters p1, p2, . . . , pk represent spans (e.g., words or tokens) from prompt P.

During the forward pass, extraction engine 316 feeds input sequence IS to the encoder of few-shot trained entity extraction model 132 to obtain contextual embeddings for the spans in the IS. In particular, let the parameter W represent the set of contextualized embeddings generated by the encoder of few-shot trained entity extraction model 132 for spans of the span sequence SS in input sequence IS. The parameter W represents the sequence: w1, w2, . . . , wn where the parameter w1 represents the contextualized embedding for span ss1 of IS, the parameter w2 represents the contextualized embedding for span ss2 of input sequence IS, and the parameter wn represents the contextualized embedding for span ssn of input sequence IS. Let the parameter Z represent the set of contextualized embeddings generated by the encoder of few-shot trained entity extraction model 132 for spans of the prompt P input sequence IS. The parameter Z represents the sequence: z1, z2, . . . , zk where the parameter z1 represents the contextualized embedding for span p1 of input sequence IS, the parameter z2 represents the contextualized embedding for span p2 of input sequence IS, and the parameter zn represents the contextualized embedding for span pk of input sequence IS.

During the forward pass, the output sequence Y generated by the decoder of few-shot trained entity extraction model 132 for the input sequence IS until time step t is represented as the parameter Y. The parameter Y represents the sequence: y1, y2, . . . , yt where y1 represents the first span of the output sequence Y, y2 represents the second span of the output sequence Y, and yt represents the t-th span of the output sequence Y at time-stamp t. The parameter S represents the corresponding feature vectors for the spans of Y. In particular, the parameter S represents the sequence: s1, s2, . . . , st for respective spans y1, y2, . . . , yt.

Extraction engine 316 generates an input sequence embedding by explicitly attending over the prompt embeddings Z. The encoder of few-shot trained entity extraction model 132 generates a contextualized embedding w1, w2, . . . , wn and z1, z2, . . . , zk for each of the spans ss1, ss2, . . . , ssn, p1, p2, . . . , pk in the input sequence IS. Additionally, a single embedding representing the input sequence is generated by involving explicit attention from the prompt embeddings z1, z2, . . . , zk. This is done by computing an attention vector for each span in the span sequence SS using the contextualized embeddings Z for the prompt P. These attention vectors are then be used to form a weighted linear combination W-Combined of the contextualized embeddings W for the span sequence SS. The steps for computing W-Combined are represented by the following two functions:

$${A}_{i} = \frac{1}{k} {\sum }_{j = 1}^{k} {a}_{ij} {t}_{j} where {a}_{ij} = cos ( {w}_{i} , {z}_{j} )$$

In the above-equation, the parameter Aᵢ represents the attention vector for the i-th span of span sequence SS and cos(wᵢ,zⱼ) represents the cosine similarity between (a) the contextualized embedding wᵢ of contextualized embeddings W for the i-th span of span sequence SS and (b) the contextualized embedding zⱼ of contextualized embeddings Z for the j-th span of prompt P.

$$W - Combined = {\sum }_{i = 1}^{n} {f}_{i} {w}_{i} where {f}_{i} = {A}_{i}^{z} {\sum }_{i = 1}^{n} {w}_{i}$$

In the above equation, the parameter W−Combined represents a weighted linear combination of the contextualized embeddings W. The parameter W−Combined plays an important role in modelling the distribution from which the next element in the output sequence is generated.

Few-shot trained entity extraction model 132 models a distribution over both a fixed vocabulary represented and the span sequence SS. The parameter P_{gen} represents the emphasis the decoder gives to the fixed vocabulary over the span sequence SS. In some embodiments, the parameter P_{gen} is represented by the following function:

P_{gen}=sigmoid(W−Combined×sₜ) where st represents the hidden state of the decoder at time step t for the most recently generated span by the decoder.

Modeling the distribution to generate the next span in the output sequence involves the computation by few-shot trained entity extraction model 132 of both the distribution over the fixed vocabulary and the distribution over the span sequence SS. Specifically, the representation of last generated span from the decoder is used for computing the distribution over the fixed vocabulary using parameters W_{vocab}, b_{vocab}.

$${P}_{vocab} = softmax ( {W}_{vocab} {S}_{t} + {b}_{vocab} )$$

Few-shot trained entity extraction model 132 also computes a distribution over the spans in the span sequence SS represented by P_{copy} such that P_{copy}(ssᵢ) is set to the cross-attention value between the encoder and decoder corresponding to span ssᵢ. Thus, the final distribution of generating the next span is governed by the following function:

$$P = {P}_{gen} {P}_{vocab} + ( 1 - {P}_{gen} ) {P}_{copy}$$

As a result of step 4, entity extraction engine 316 obtains an output sequence from few-shot trained entity extraction model 132 for each test prompt sequence in test prompt sequences 324 that is input to few-shot trained entity extraction model 132. Each test prompt sequence of test prompt sequences 324 corresponds to one target entity type. The prompt of each test prompt sequence is generated by test prompt retrieval engine 314 for the test span sequence of the test prompt sequence and the corresponding target entity type. The output sequence identifies any entities in the test span sequence that are instances of the target entity type. The form of the output sequence varies depending on the form of the ground truth output sequences used to train pre-trained entity extraction model 130 during the training phase. One possible form is a template form in which entities are delimited by tags. For example, if the target entity type is short name and the teste span sequence is “This Employment Agreement (the “Agreement”) is made as of Mar. 7, 2018, by and between Acme, Inc., a Michigan corporation (the “Company”), and Sally Boss (“Executive”), subject to the terms and conditions defined in this Agreement,” then the output sequence could be: “This Employment Agreement (the “Agreement”) is made as of Mar. 7, 2018, by and between Acme, Inc., a Michigan corporation (the “<SOE>Company</>”), and Sally Boss (“<SOE>Employee</>”), subject to the terms and conditions defined in this Agreement.” In this example, the tags “<SOE> . . . </>” are used to delimit an instance of the short name target entity type in the test span sequence. As another example, the output sequence could be in an explanation form such as: “‘Company’ is an instance of SHORT NAME. ‘Employee’ is an instance of SHORT NAME.”

At step 5, extracted entities 340 are provided to client device 118. Extracted entities 340 encompass the entities extracted from test documents 320 and for each such extracted entity an indication or identifier of its target entity type and an indication or identifier of its location within test documents 320.

### Obtaining Annotated Training Data

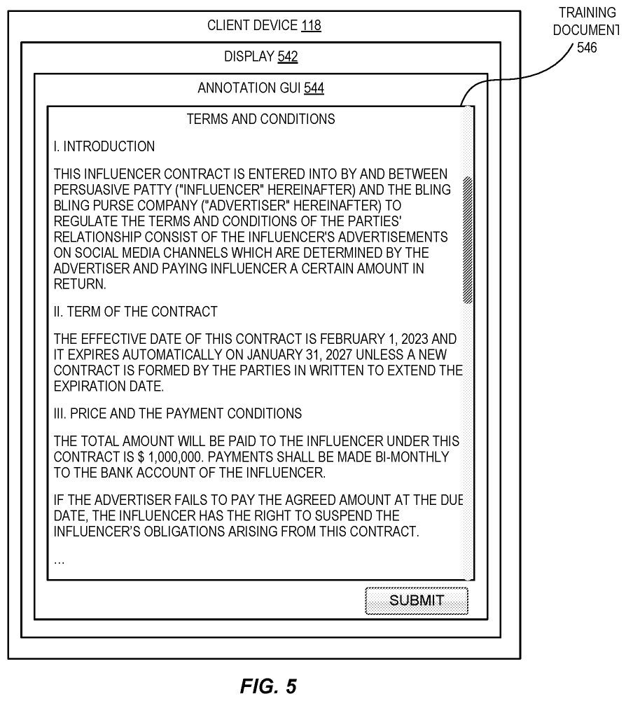

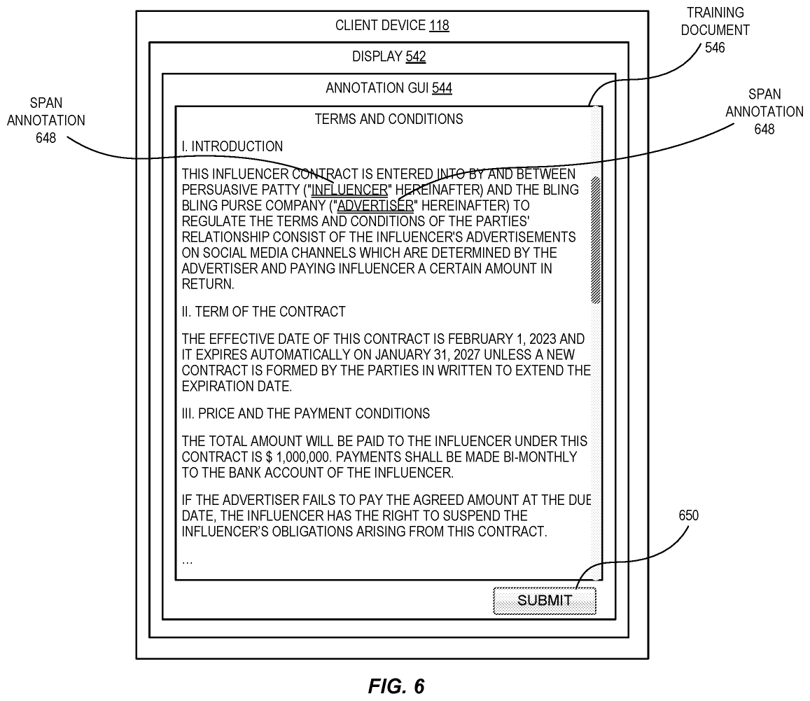

FIG. 5 and FIG. 6 illustrate a technique for obtaining an annotated training document, according to an embodiment. Text of the training document 546 is displayed as part of an annotation graphical user interface 544 displayed on a video display 542 of or operatively coupled to client device 118. As shown in FIG. 6, a user with user input to the client device 118 selects one or more spans of the training document 546 to annotate 648 them as instances of an arbitrary new entity type (e.g., “SHORT NAME”). Once the user has finished annotating spans 648 of the training document 546, the user directs user input to client device 118 to select the submit button 650 of annotation GUI 544. Such selection causes span annotation metadata representing the span annotations 648 to be sent to pipeline system 100.

### Providing Extracted Entities

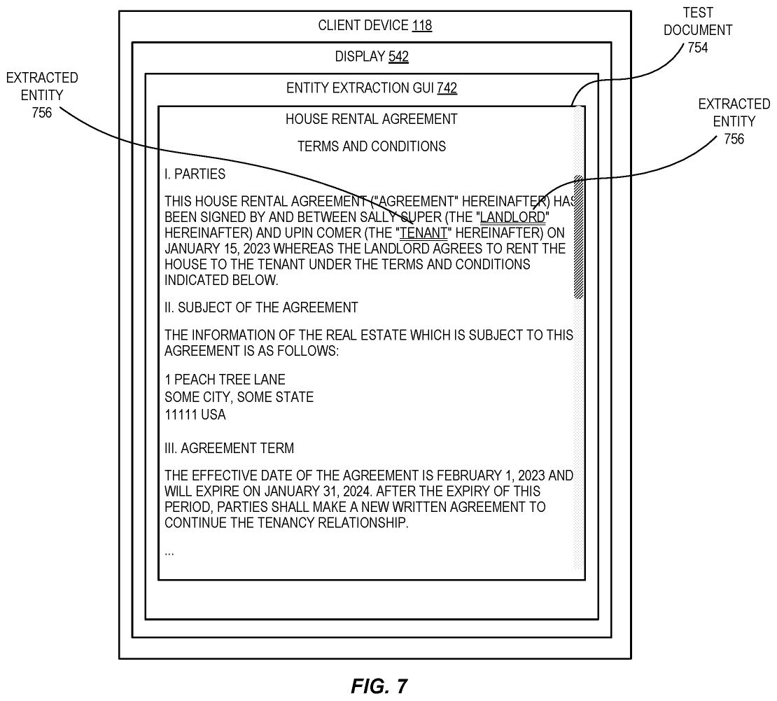

FIG. 7 illustrates a technique for providing extracted entities to client device 118, according to an embodiment. Text of a test document 754 is displayed as part of an entity extraction graphical user interface 742 that is displayed on the video display 542 of or operatively coupled to client device 118. Text of test document 754 corresponding to extracted entities 756 is highlighted or otherwise indicated in GUI 742. For example, the indicated text “LANDLORD” and “TENANT” may be extracted as instances of a SHORT NAME entity type.

### Example Pipeline System

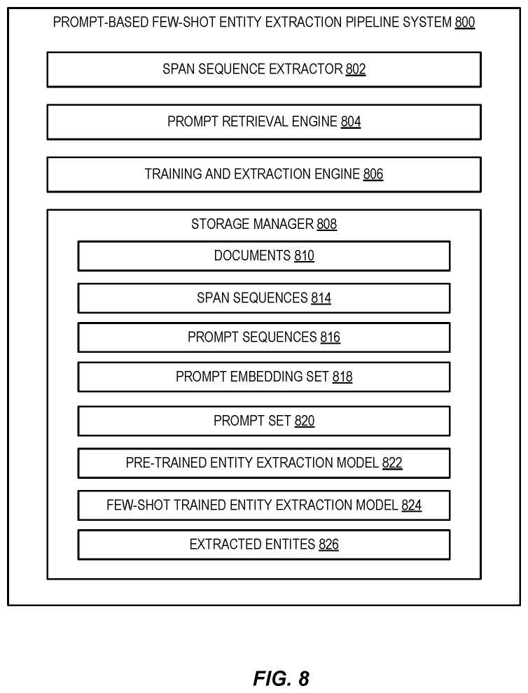

FIG. 8 illustrates a schematic diagram of prompt-based few-shot entity extraction pipeline system described above in accordance with an embodiment. As shown, pipeline system 800 includes span sequence extractor 802, prompt retrieval engine 804, and training and extraction engine 806. Pipeline system 800 also includes storage manager 808 for storing documents 810, span sequences 814, prompt sequences 816, prompt embedding set 818, prompt set 820, pre-trained entity extraction model 822, few-shot trained entity extraction model 824, and extracted entities 826.

Pipeline system 800 includes span sequence extractor 802. Span sequence extractor 802 extracts span sequences 814 from documents 810. In particular, during a training phase, span sequence extractor 802 extracts training span sequences from a set of one or more training documents of documents 810. During an entity extraction phase, span sequence extractor 802 extracts test span sequences from a set of one or more test documents of documents 810. In the case of the set of training documents, span sequence extractor 802 extracts training span sequences from the set of training documents that encompass annotated spans. A training span sequence can be a phrase, a sentence, a paragraph, or other portion of a training document in which an annotated span occurs. A span is a sequence of one or more words or other character sequence in a document. An annotated span is a span that is identified or marked by annotation metadata as an instance of a particular entity. In the case of the set of test documents, span sequence extractor 802 extracts test span sequences from the set of test documents. A test span sequence can be a phrase, a sentence, a paragraph, or other portion of a test document for entity extraction.

Extracting a span sequence from a document of documents 810 by span sequence extractor 802 can involve various natural language processing techniques such as, for example, any or all of: tokenization, part-of-speech tagging, parsing, dependency parsing, constituency parsing, named entity recognition, or other suitable natural language processing technique.

Pipeline system 800 includes prompt retrieval engine 804. Prompt retrieval engine 804 generates prompt sequences 816 for span sequences 814. Prompt retrieval engine 804 performs different operations during the training phase and the extraction phase.

During the training phase, prompt retrieval engine 804 obtains a label set of training span sequences for a target entity type extracted from the set of training documents by span sequence extractor 802. Prompt retrieval engine 804 templatizes each training span sequence in the label set and generates a prompt embedding for each templatized training span sequence in the label set. The generated prompt embeddings and the templatized training span sequences are added by prompt retrieval engine 804 to prompt embedding set 818 and prompt set 820, respectively. For each templatized training span sequence in the label set, prompt retrieval engine 804 compares the prompt embedding generated for the templatized training span sequence to each other prompt embedding generated for each other templatized span sequence in the label set. Based on the comparisons, prompt retrieval engine 804 selects the most similar of the other templatized training span sequences in the label set and forms a training prompt sequence for the templatized training span sequence by combining it with the most similar of the other templatized training span sequences. The formed training prompt sequence can be stored as part of prompt sequences 816.

During the extraction phase, for each test span sequence extracted by span sequence extractor 802 from a test document, prompt retrieval engine 804 compares a prompt embedding generated for the test span sequence to each prompt embedding of prompt embedding set 818 for each prompt sequence of prompt sequences 816 for a target entity type to be extracted. For example, these prompt embeddings and prompt sequences can be those added to prompt embedding set 818 and prompt set 820, respectively, by prompt retrieval engine 804 for the target entity type during the training phase. Prompt retrieval engine 804 selects the prompt sequence of prompt sequences 816 for the target entity type that is most similar to the test span sequence and forms a test prompt sequence for the test span sequence by combining it with the most similar prompt sequence. The test prompt sequence formed can be stored as part of prompt sequences 816.

Pipeline system 800 includes training and extraction engine 806. During the training phase, training and extraction engine 806 trains pre-trained entity extraction model 822 based on the training prompt sequences of prompt sequences 816 generated by prompt retrieval engine 804. Training and extraction engine 806 trains pre-trained entity extraction model 822 according to a sequence-to-sequence objective modelled with explicit attention from the prompts in the training prompt sequences over the corresponding training span sequences in the training prompt sequences resulting in few-shot trained entity extraction model 824. During the extraction phase, training and extraction engine 806 uses few-shot trained entity extraction model 824 to infer (extract) entities 826 of a target entity type in the set of test documents. Training and extraction engine 806 does this based on test prompt sequences of prompt sequences 816 generated by prompt retrieval engine 804. The resulting extracted entities 826 are then provided to a client device (e.g., for presentation in a user interface such as depicted in FIG. 7).

Each of the components 802-808 of the system 800 and their corresponding elements (as shown in FIG. 8) may be in communication with one another using any suitable communication technologies. It will be recognized that although components 802-808 and their corresponding elements are shown to be separate in FIG. 8, any of components 802-808 and their corresponding elements may be combined into fewer components, such as into a single facility or module, divided into more components, or configured into different components as may serve a particular embodiment.

The components 802-808 and their corresponding elements can comprise software, hardware, or both. For example, the components 802-808 and their corresponding elements can comprise one or more instructions stored on a computer-readable storage medium and executable by processors of one or more processing devices. When executed by the one or more processors, the computer-executable instructions of the entity extraction system 800 can cause a client device or a server device to perform the methods described herein. Alternatively, the components 802-808 and their corresponding elements can comprise hardware, such as a special purpose processing device to perform a certain function or group of functions. Additionally, the components 802-808 and their corresponding elements can comprise a combination of computer-executable instructions and hardware.

Furthermore, the components 802-808 of the entity extraction system 800 may, for example, be implemented as one or more stand-alone applications, as one or more modules of an application, as one or more plug-ins, as one or more library functions or functions that may be called by other applications, or as a cloud-processing model. Thus, the components 802-808 of the entity extraction system 800 may be implemented as a stand-alone application, such as a desktop or mobile application. Furthermore, the components 802-808 of the entity extraction system 800 may be implemented as one or more web-based applications hosted on a remote server. Alternatively, or additionally, the components of the entity extraction system 800 may be implemented in a suite of mobile device applications or “apps.”

As shown, the entity extraction system 800 can be implemented as a single system. In other embodiments, the entity extraction system 800 can be implemented in whole, or in part, across multiple systems. For example, one or more functions of the entity extraction system 800 can be performed by one or more servers, and one or more functions of the entity extraction system 800 can be performed by one or more client devices. The one or more servers or one or more client devices may generate, store, receive, and transmit any type of data used by the entity extraction system 800, as described herein.

In one implementation, one or more client devices can include or implement at least a portion of the entity extraction system 800. In other implementations, one or more servers can include or implement at least a portion of the entity extraction system 800. For instance, the entity extraction system 800 can include an application running on one or more servers or a portion of the entity extraction system 800 can be downloaded from one or more servers. Additionally or alternatively, the entity extraction system 800 can include a web hosting application that allows the client device(s) to interact with content hosted at the one or more server(s).

The server(s) or client device(s) may communicate using any communication platforms and technologies suitable for transporting data or communication signals, including any known communication technologies, devices, media, and protocols supportive of remote data communications, examples of which will be described in more detail below with respect to FIG. 10. In some embodiments, the server(s) or client device(s) communicate via one or more networks.

A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 10.

The server(s) may include one or more hardware servers (e.g., hosts), each with its own processing resources (e.g., processors, memory, disk space, networking bandwidth, etc.) which may be securely divided between multiple customers (e.g., client devices), each of which may host their own applications on the server(s). The client device(s) may include one or more personal computers, laptop computers, mobile devices, mobile phones, tablets, special purpose computers, TVs, or other processing devices, including processing devices described below with regard to FIG. 10.

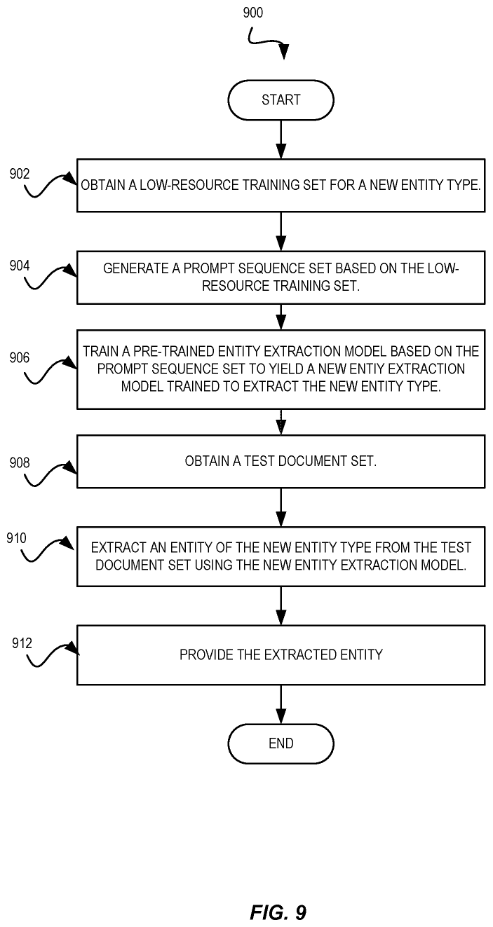

FIGS. 1-8, the corresponding text, and the examples, provide a number of different systems and devices for entity extraction. In addition to the foregoing, embodiments can also be described in terms of flowcharts comprising acts and steps in a method for accomplishing a particular result. For example, FIG. 9 illustrates a flowchart of an exemplary method in accordance with one or more embodiments. The method described in relation to FIG. 9 may be performed with fewer or more steps/acts or the steps/acts may be performed in differing orders. Additionally, the steps/acts described herein may be repeated or performed in parallel with one another or in parallel with different instances of the same or similar steps/acts.

### Example Method

FIG. 9 illustrates a flowchart 900 of a series of acts in a method of prompt-based few-shot entity extraction, in accordance with one or more embodiments. In one or more embodiments, the method 900 is performed in a digital medium environment that includes the few-shot entity extraction system 800. The method 900 is intended to be illustrative of one or more methods in accordance with the present disclosure and is not intended to limit potential embodiments. Alternative embodiments can include additional, fewer, or different steps than those articulated in FIG. 9.

As illustrated in FIG. 9, the method 900 includes an act 902 of obtaining an annotated natural language document set (training set) for an arbitrary new entity type. The train set can be obtained in various ways. No particular way is required. For example, the training set can be obtained using the technique described above with respect to FIG. 5 and FIG. 6 where a user is provided a graphical user interface at their client device for annotating spans of a training document identifying them instances of the arbitrary new entity type. The technique can be repeated for each training document. Additionally, or alternatively, a training document can be obtained from a database, cloud storage service, or network-connected file system.

The method 900 also includes an act 904 of generating a prompt sequence set based on the annotated natural language document set. This can include extracting training span sequences from the training set and generating training prompt sequences as described in greater detail herein with respect to FIG. 1 and FIG. 2.

The method 900 also includes an act 906 of training a pre-trained natural entity extraction model based on the prompt sequence set to yield a few-shot trained entity extraction model. This can include training the pre-trained entity extraction model based on the prompt sequence set to yield the few-shot trained entity extraction model as described in greater detail herein with respect to FIG. 1.

The method 900 also includes an act 908 of obtaining a test document set from which to extract the arbitrary new entity type. The test document set can be obtained in various ways. No particular way is required. For example, the test document set can be obtained from a client device by being uploaded from the client device. Additionally, or alternatively, a test document can be obtained from a database, cloud storage service, or network-connected file system.

The method 900 also includes an act 910 of extracting an entity of the arbitrary new entity type from the test document set using the few-shot trained entity extraction model. This can include extracting test span sequences from the test set, generating test prompt sequences from the extracted test span sequences, and inferring extracted entities using the few-shot trained entity extraction model and based on the test prompt sequences as described in greater detail herein with respect to FIG. 3 and FIG. 4.

The method 900 also includes an act 912 of providing an entity extracted from the test set that is an instance of the arbitrary new entity type. For example, the extracted entity can be provided to a client device for display to a user of the client device in the manner depicted in FIG. 7. The extracted entity and associated metadata could additionally or alternatively be provided to a database or other web service for storage or additional processing.

### Example Processing Device

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more processing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions.

In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network processing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be in both local and remote memory storage devices.

Embodiments of the present disclosure can also be implemented in cloud processing environments. In this description, “cloud processing” is defined as a model for enabling on-demand network access to a shared pool of configurable processing resources. For example, cloud processing can be employed in the marketplace to offer ubiquitous and convenient on-demand access to the shared pool of configurable processing resources. The shared pool of configurable processing resources can be rapidly provisioned via virtualization and released with low management effort or service provider interaction, and then scaled accordingly.

A cloud-processing model can be composed of various characteristics such as, for example, on-demand self-service, broad network access, resource pooling, rapid elasticity, measured service, and so forth. A cloud-processing model can also expose various service models, such as, for example, Software as a Service (“SaaS”), Platform as a Service (“PaaS”), and Infrastructure as a Service (“IaaS”). A cloud-processing model can also be deployed using different deployment models such as private cloud, community cloud, public cloud, hybrid cloud, and so forth. In this description and in the claims, a “cloud-processing environment” is an environment in which cloud processing is employed.

FIG. 10 illustrates, in block diagram form, an exemplary processing device 1000 that may be configured to perform one or more of the processes described above. One will appreciate that one or more processing devices such as the processing device 1000 may implement the prompt-based few-shot entity extraction system 800. As shown by FIG. 10, the processing device can comprise a processor 1002, memory 1004, one or more communication interfaces 1006, a storage device 1008, and one or more I/O devices/interfaces 1010. In certain embodiments, the processing device 1000 can include fewer or more components than those shown in FIG. 10. Components of processing device 1000 shown in FIG. 10 will now be described in additional detail.

In some embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1008 and decode and execute them. In various embodiments, the processor(s) 1002 may include one or more central processing units (CPUs), graphics processing units (GPUs), field programmable gate arrays (FPGAs), systems on chip (SoC), or other processor(s) or combinations of processors.

The processing device 1000 includes memory 1004, which is coupled to the processor(s) 1002. The memory 1004 may be used for storing data, metadata, and programs for execution by the processor(s). The memory 1004 may include one or more volatile and non-volatile memories, such as Random Access Memory (“RAM”), Read Only Memory (“ROM”), a solid-state disk (“SSD”), Flash, Phase Change Memory (“PCM”), or other types of data storage. The memory 1004 may be internal or distributed memory.

The processing device 1000 can further include one or more communication interfaces 1006. A communication interface 1006 can include hardware, software, or both. The communication interface 1006 can provide one or more interfaces for communication (such as, for example, packet-based communication) between the processing device and one or more other processing devices 1000 or one or more networks. As an example, and not by way of limitation, communication interface 1006 may include a network interface controller (NIC) or network adapter for communicating with an Ethernet or other wire-based network or a wireless NIC (WNIC) or wireless adapter for communicating with a wireless network, such as a WI-FI. The processing device 1000 can further include a bus 1012. The bus 1012 can comprise hardware, software, or both that couples components of processing device 1000 to each other.

The processing device 1000 includes a storage device 1008 includes storage for storing data or instructions. As an example, and not by way of limitation, storage device 1008 can comprise a non-transitory storage medium described above. The storage device 1008 may include a hard disk drive (HDD), flash memory, a Universal Serial Bus (USB) drive or a combination of these or other storage devices. The processing device 1000 also includes one or more input or output (“I/O”) devices/interfaces 1010, which are provided to allow a user to provide input to (such as user strokes), receive output from, and otherwise transfer data to and from the processing device 1000. These I/O devices/interfaces 1010 may include a mouse, keypad or a keyboard, a touch screen, camera, optical scanner, network interface, modem, other known I/O devices or a combination of such I/O devices/interfaces 1010. The touch screen may be activated with a stylus or a finger.

The I/O devices/interfaces 1010 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1010 are configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
obtaining a test document set;
generating a test prompt sequence set based on the test document set; and
extracting an entity of a particular entity type from the test document set using the test prompt sequence set and a few-shot entity extraction model trained to extract at least the particular entity type.

2. The method of claim 1, wherein the few-shot entity extraction model is trained to extract at least the particular entity type based on a training prompt sequence set, wherein the training prompt sequence set is generated using an annotated document set for the particular entity type.

3. The method of claim 2, wherein the training prompt sequence set includes a span sequence set from the annotated document set, wherein each span sequence of the span sequence set comprises at least one annotated instance of the particular entity type, and wherein each span sequence of the span sequence set is associated with a respective prompt that is determined to be similar to the span sequence.

4. The method of claim 2, wherein the annotated document set for the particular entity type is obtained via a graphical user interface for annotating spans of a natural language document as instances of the particular entity type.

5. The method of claim 1, wherein an embedding representing a particular span sequence is generated by explicitly attending over one or more prompt embeddings.

6. The method of claim 5, wherein explicitly attending over the one or more prompt embeddings comprises determining a numerical emphasis for a decoder of the few-shot entity extraction model to place on (a) a distribution over a fixed vocabulary over (b) a distribution over the span sequence.

7. The method of claim 2, wherein the annotated document set comprises less than twenty documents and fewer than four annotated instances of the particular entity type per document.

8. The method of claim 2, wherein the few-shot entity extraction model comprises a Copy BART sequence-to-sequence natural language machine learning model.

9. The method of claim 1, further comprising:
providing the extracted entity to a client device.

10. A non-transitory computer-readable medium storing executable instructions, which when executed by a processing device, cause the processing device to perform operations comprising:
obtaining a first set of documents from the processing device, wherein one or more spans of the first set of documents are annotated as instances of a particular entity type;
generating a training prompt sequence set based on the first set of documents; and
training, by a prompt-based few-shot entity extraction system, a pre-trained entity extraction model based on the training prompt sequence set to yield a few-shot entity extraction model trained to extract at least the particular entity type.

11. The non-transitory computer-readable medium of claim 10, wherein the operation of generating a training prompt sequence set based on the first set of documents further comprises:
extracting a span sequence set from the first set of documents, wherein each span sequence of the span sequence set comprises at least one annotated instance of the particular entity type;
determining a classification embedding for a span sequence of the span sequence set; and
using the classification embedding to determine a prompt in a prompt set that is similar to the span sequence.

12. The non-transitory computer-readable medium of claim 10, wherein the prompt-based few-shot entity extraction system is remote from the processing device.

13. The non-transitory computer-readable medium of claim 10, wherein the operation of training, by a prompt-based few-shot entity extraction system, a pre-trained entity extraction model based on the training prompt sequence set to yield a few-shot entity extraction model trained to extract at least the particular entity type, further comprises:
obtaining a set of contextualized feature vectors from an encoder of the pre-trained entity extraction model, the set of contextual feature vectors comprising a respective contextualized feature vector for each span of a span sequence and for each span of a prompt generated for the span sequence, the span sequence extracted from a document in the first set of documents, the span sequence comprising at least one instance of the particular entity type;
generating an embedding representing the span sequence by explicitly attending over the respective contextual feature vectors obtained for each span of the prompt generated for the span sequence; and
using the generated embedding representing the span sequence to model a distribution from which a next span in an output sequence is generated.

14. A system comprising:
a memory component; and
one or more processing devices coupled to the memory component and to perform operations comprising:
obtaining a test document set;
generating a test prompt sequence set based on the test document set; and
extracting an entity of a particular entity type from the test document set using the test prompt sequence set and a few-shot entity extraction model trained to extract at least the particular entity type.

15. The system of claim 14, wherein the few-shot entity extraction model is trained to extract at least the particular entity type based on a training prompt sequence set, wherein the training prompt sequence set is generated using an annotated document set for the particular entity type.

16. The system of claim 15, wherein the training prompt sequence set includes a span sequence set from the annotated document set, wherein each span sequence of the span sequence set comprises at least one annotated instance of the particular entity type, and wherein each span sequence of the span sequence set is associated with a respective prompt that is determined to be similar to the span sequence.

17. The system of claim 15, wherein the annotated document set for the particular entity type is obtained via a graphical user interface for annotating spans of a document as instances of the particular entity type.

18. The system of claim 15, wherein an embedding representing a particular span sequence is generated by explicitly attending over one or more prompt embeddings.

19. The system of claim 18, wherein explicitly attending over the one or more prompt embeddings comprises determining a numerical emphasis for a decoder of the few-shot entity extraction model to place on (a) a distribution over a fixed vocabulary over (b) a distribution over the span sequence.

20. The system of claim 14, the operations further comprising:
providing the entity extracted to a client device.
